(19) United States
(12) Patent Application Publication
(10) Pub. No.: US 2002/0184647 A1
(43) Pub. Date: Dec. 5, 2002

(54) System and computer readable medium for accessing program content information and method thereof

(76) Inventor: Anton V. Komar, Toronto (CA)

Correspondence Address: SIMON, GALASSO & FRANTZ PLC, P.O. BOX 26503, AUSTIN, TX, 78755-0503, US

(21) Appl. No.: 09/871,917

(22) Filed: Jun. 1, 2001

(51) Int. Cl. H04N 7/173; H04N 5/445

(52) U.S. Cl. 725/110; 725/109; 725/37; 725/32; 725/131

(57) ABSTRACT

Systems and a method are provided for accessing and providing information related to a particular multimedia program. A user provides a request for program content information, including a time and a channel associated with a program of interest. The time and channel are provided to a program guide to access a title associated with the particular program. The title is provided to an Internet-based information database to receive program content information related to the provided title. A portion of the program content information is presented on a display along with the program itself. The user may select a level of detail associated with the program content information to be displayed along with program content.

### FIELD OF THE DISCLOSURE

The present invention relates generally to multimedia systems and more particularly to providing program content information.

### BACKGROUND

Several options are provided for a user to access multimedia programming. Digital and analog cable television provides various channels for the user to receive different television programs in the privacy of his home. Digital video disks (DVD) and video-cassettes also provide access to multimedia content for the home user. As more multimedia programs are available, it becomes increasingly difficult for the user to decide which of the many available programs to watch.

In response to a desire for more program selection information, interactive program guides are now offered to users. The interactive program guides allow users to view a listing of program titles on corresponding television or satellite channels. The user may then have a better opportunity to identify programs the user would enjoy. Some televisions are being equipped with interactive program guides to provide access on a main display device. Information regarding a particular program is restricted to the contents of that interactive program guide's database. However, this information is not always enough. Users generally want more description regarding a particular program.

Program databases are available, over the Internet, to allow a user to receive information regarding a particular program. The user submits a title associated with the program and the interactive program database provides a variety of information to the user about the program. The information includes actor listings, descriptions, and general production information. However, the user must determine the title of the show, connect to the Internet and search to find desired information about the program, which can be time consuming and provides little advantage to the user. From the above discussion, it is apparent that a method addressing at least some of the shortcomings of currently available program content information sources is needed.

### BRIEF DESCRIPTION OF THE DRAWINGS

Specific embodiments of the present invention are shown and described in the drawings presented herein. Various objects, advantages, features and characteristics of the present invention, as well as methods, operations and functions of related elements of structure, and the combination of parts and economies of manufacture, will become apparent upon consideration of the following description and claims with reference to the accompanying drawings, all of which form a part of this specification, and wherein:

FIG. 1 is a block diagram illustrating a system for providing program content information to a user, according to one embodiment of the present invention;

FIG. 2 is a setup menu display for configuring options associated with the system from FIG. 1, according to one embodiment of the present invention;

FIG. 3 is a display screen for illustrating the presentation of program content information to a user, according to one embodiment of the present invention;

FIG. 4 is a flow diagram illustrating a method of accessing program content information, according to one embodiment of the present invention; and

FIG. 5 is a block diagram illustrating a more detailed implementation of the system from FIG. 1, according to one embodiment of the present invention.

### DETAILED DESCRIPTION OF THE FIGURES

At least one embodiment of the present invention provides a method for accessing and displaying program content information to a user. The method includes obtaining a program identifier from a program database. The program identifier is associated with a particular program. For example, the program identifier may include the title of the particular program. The particular program may include a television program being decoded from a television channel. In one embodiment, the program database includes an interactive program guide provided with a broadcast signal. In another embodiment, the program database is accessed from an Internet-based program guide. A channel and time associated with the particular program is provided to the Internet-based program guide.

The method also includes accessing program content information, associated with the program identifier, from an information database. In one embodiment, the information database includes an Internet website for providing program content information. In another embodiment, the information database includes an Internet search engine for locating program content information. The program content information is information associated with the program identifier. The method further includes providing a portion of the program content information to a user. In on embodiment, the program content information is presented on a display, allowing the user to watch the particular program while receiving information about the program. An advantage of at least one embodiment of the present invention is that information related to a particular multimedia program may be automatically accessed and presented to a user.

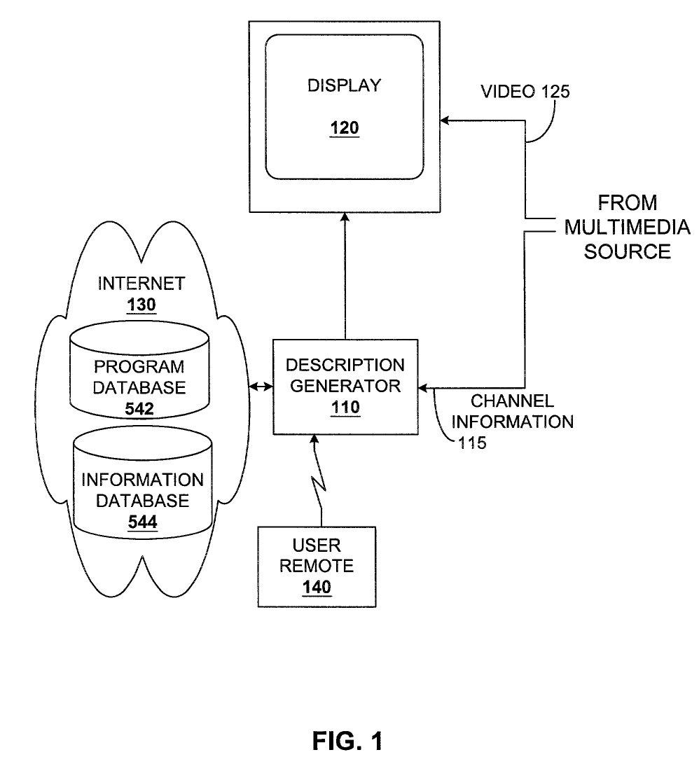

Referring now to FIG. 1, a block diagram illustrating a system for providing program content information to a user is shown, according to one embodiment of the present invention. A multimedia device, such as display 120 is used to present multimedia content, such as video 125, from a multimedia source (not shown). Description generator 110 is used to access and provide information related to a particular program, such as a program associated with video 125. Video 125 and information related to the particular program are both presented to a user through display 120.

Multimedia content, such as video 125, is generated through the multimedia source. The multimedia source may include an analog or digital television tuner. The television tuner selects a particular television channel and decodes video content into video 125. One or more tuners (not shown) may also provide sources of multimedia content, such as digital satellite receivers (not shown). Display 120 displays the decoded content, video 125. Alternatively, the multimedia device may include a speaker system (not shown) for receiving audio content from the multimedia source, such as from a radio.

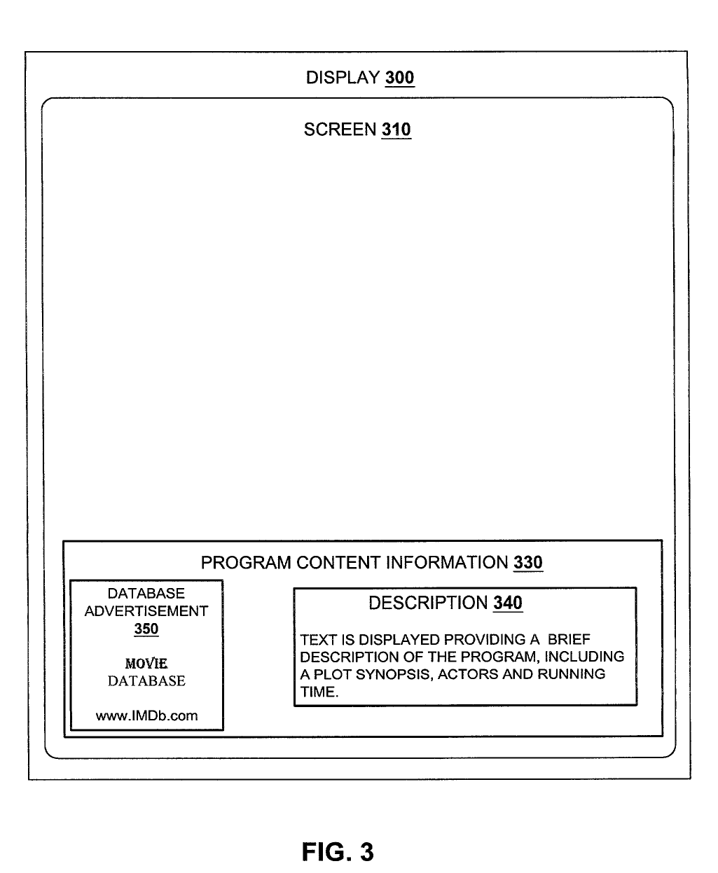

In one embodiment, a user requests to receive information regarding a program broadcast on a particular channel. The user may make the request by pressing a ‘description’ button provided on user control 140, or by other suitable selection means. User control 140 may include an infrared or radio frequency remote control used by the user to select a program to get information about. Description generator 1 10 provides information associated with a program on display 120. Display 120 may then present the information to a user while still providing a presentation of video 125, as shown in FIG. 3. In one embodiment, description generator 1 10 receives channel information 115 associated with the particular channel from which the multimedia source is providing video 125, for example a particular channel or station to which a television is tuned. In one embodiment, the user specifies channel information 115 and the time through user control 140. By specifying the channel, the user may continue to watch a current program while requesting information about a different program. By providing the time, the user may request information about a program to be displayed at a future time.

In one embodiment, the description generator 110 accesses a program guide provided through Internet 130 to determine a program identifier associated with a particular program at a particular time. Description generator 110 provides the channel information 115 to a program database 542, accessible through Internet 130. In one embodiment, a time is also provided to program database 542. The time may be generated through a local clock (not shown) associated with description generator 110. The time and the channel information may be used by program database 542 to identify the particular program being presented on the channel at the specified time. The program identifier may include the title of the program, an episode number, an airing date, or other suitable identifying information. In an alternate embodiment, program database 542 is accessible to the multimedia source. The multimedia source includes an interactive program guide that is capable of providing the program identifier. In an alternate embodiment, the program is a radio program, such as a particular song being played on a selected radio station. The Internet 130 may be used to access program database 542 to provide a user with a title of the particular song being aired on the radio at that time.

Description generator 110 provides the program identifier to an information database 544 on Internet 130. Information database 544 allows the program identifier to be used to search for information about the program associated with the program identifier. In one embodiment, information database 544 includes an Internet-based movie database that includes information related to various multimedia programs. Alternatively, information database 544 may include information returned through a search engine on Internet 130. A search engine is a remotely accessible program that allows a user to do keyword searches for information in a network, such as Internet 130. The program identifier may be provided to the search engine to return sites that contain information associated with the associated program. Information database 544 returns information associated with the particular program to description generator 110.

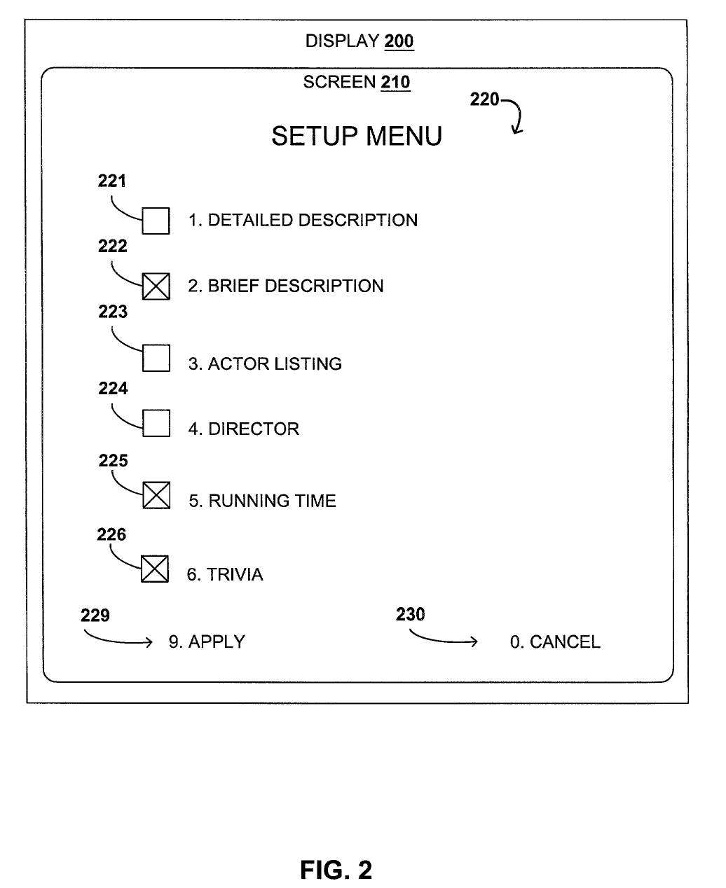

Description generator 1 10 provides a representation of the received information to the user. In one embodiment, the user selects various options for the levels of information to be presented, as described in reference to FIG. 2. For example, the user may request to be provided only a brief description of the program or a list of actors in the particular program, through user control 140. Description generator 110 selects portions of the information that match the requests from the user. In one embodiment, the selected information is displayed on display 120. The user may continue to watch a current program while receiving information regarding the current program, or another selected program.

Referring now to FIG. 2, a setup menu display for configuring options associated with the system from FIG. 1 is shown, according to one embodiment of the present invention. A display 200 is used to present video content related to a particular program. As previously described in reference to FIG. 1, a user may select to receive different levels of description related to the particular program. A large amount of information may be available for a particular program. The information available may be enough to take over the majority of screen 210 on display 200. Consequently, if the program is to be displayed along with the information, the information may become overwhelming, taking away from the enjoyment of watching a program. Accordingly, the user may be provided a setup menu 220 to select options from options 221-225, related to the amount of information to be displayed at one time. In one embodiment, the user selects from options 221-230 through a user control 140 (FIG. 1), such as a remote control. The user may press a ‘menu’ button on user control 140 to display setup menu 220 on screen 210 of display 200.

Options 221 and 222 provide control over a level of detail display. Option 221 may be used to select a detailed description. The detailed description may provide a lengthy description of the selected program, such as a detailed description of events and/or characters in the program. Alternatively, option 222 may be used to select a brief description. In comparison to the detailed description, the brief description may provide a short summary or synopsis of the program, providing a plot summary. It should be appreciated that various intermediate levels of detail may also be offered.

Option 223 may be used to receive a listing of actors in the program. In one embodiment, the actor listing includes only actors related to main characters of the program. Option 224 may be used to receive information related to a director of the program. Option 225 is used to select to receive a running time of the particular program, allowing a user to decide whether they have enough time to watch the particular program. Option 226 is used to select to receive trivia information associated with the program. Trivia information related to the actors, production and/or filming of the program may be provided to the user. In one embodiment, a description generator, such as description generator 110 (FIG. 1), uses the selected options of options 221-226 to filter the information received related for a particular program. It should be appreciated that other options may also be included, such as an option to receive parental ratings or an option to disable the information feature completely without departing from the scope of the present invention.

In one embodiment, the description generator 110 (FIG. 1) limits the number of options the user may select, due to space limitations associated with screen 210. For example, the user may be prohibited from selecting the option 222, for displaying a brief description, after selecting option 221, for a detailed description. Once the user has selected preferences from options 221-226, the user may select option 229 to apply the selected preferences, or option 230 to discard the selected options. If option 230 is selected, the preferences use a previously stored set of preferences. In one embodiment, if no preferences are selected, the description generator relies on a set of default settings factory-installed during production of the description generator. The selected options may then be displayed with video associated with a multimedia program on a display, such as display 200, as described in reference to FIG. 3.

Referring now to FIG. 3, a display screen for illustrating the presentation of program content information to a user is shown, according to one embodiment of the present invention. Display 200 is used to present video content related to a multimedia program, on screen 310. Program content information 330 is provided to present information to a user, descriptive of either the program being watched or another multimedia program.

As previously discussed, information regarding a particular program is accessed from an external database, such as through the Internet. The information is filtered through a collection of user settings or options, as described in reference to FIG. 2. The selected information, description 340, is provided to the user through a portion of screen 310, such as program content information 330. Description 340 provides the user with information regarding a program on a selected channel being presented at a specific time. Description 340 may include a detailed description, brief plot synopsis, actor/director listing and a running time associated with the program. In one embodiment, description 340 is provided in a scrolling format, wherein the information scrolls across the lower portion of the screen designated by program content information 330. In another embodiment, the user may use a remote control to selectively scroll through the information available through description 340. Alternatively, description 340 includes only a number of text characters that fit the portion specified by program content information 330.

In one embodiment, a description generator handles communication with a program content information database to access the information related to a selected program, over the Internet. In one embodiment, an agreement is made with an owner of the program content information database to access the database. The agreement may include an offer to display a logo or advertisement related to the information database used. For example, in one embodiment, an Internet-based movie database, www.imdb.com, is used to access program content information. Accordingly, a database advertisement 350 can be provided to acknowledge the use of the Internet-based movie database.

In one embodiment, program content information is presented on top of video related to a multimedia program. Program content information 330 may be provided translucent, to allow the portion of the video covered by program content information 330 to still be seen. Alternatively, the portion of video being displayed may be shrunk on screen 310, to allow program content information 330 to be displayed without covering any of the video from the program. In one embodiment, description 340 is associated with the current program being displayed. In another embodiment the user selects different programs to receive information about, while still watching a current program. Alternatively, the displayed program may be changed while the description 340 continues to relate to another program.

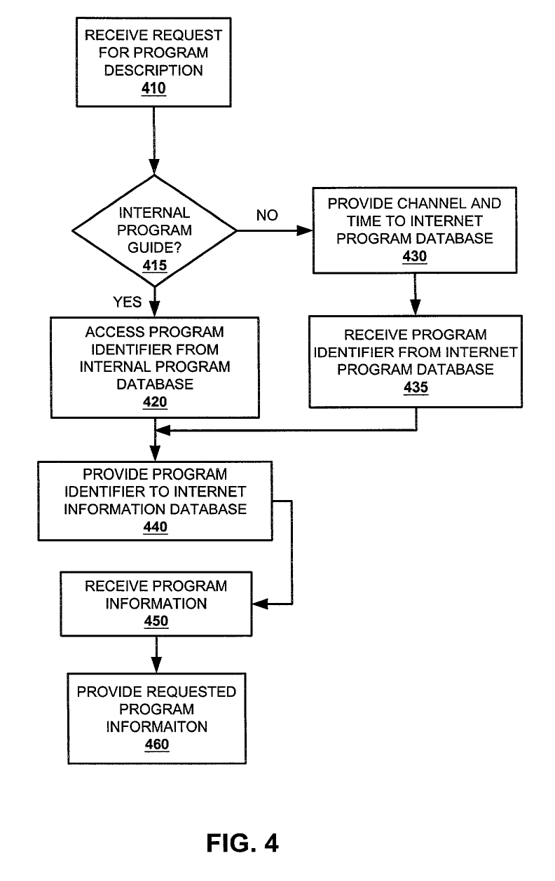

Referring now to FIG. 4, a flow diagram illustrating a method of accessing program content information is shown, according to one embodiment of the present invention. A description generator is used to identify and provide information related to a particular program provided by a multimedia source device. The multimedia source device may include a television tuner, satellite receiver, or a radio tuner. The information is then presented to a user through a media device. In one embodiment, the information is presented through a display, as shown in FIG. 3.

In step 410, the description generator receives a request for program content information. In one embodiment, a user generates the request through a remote control, such as user control 140 (FIG. 1). The user may select a channel and a time to indicate the program to receive information about. The time and channel may be provided to select a future program to be presented at a future time. Alternatively, the user may only provide a channel. Accordingly, the current time is used. In one embodiment, the user simply requests information related to a current program. In such a case, the current channel and time are used. In one embodiment, the program is a television program or movie. In another embodiment, the program is a radio program, such as a particular song.

In step 415 it is determined if the multimedia source device includes an internal program database, such as an interactive program guide. An internal program database may be provided with the multimedia source device to display current and future programs to be presented over various channels. In step 415, if an internal program database is available, the description generator accesses a program identifier from the internal program database, as in step 420. The program identifier is an identifier unique to the program identified. If no internal program database was available in step 415, the description generator must access an external program database, as in step 430. The description generator provides a time and channel, as provided by the user, to a program database. In one embodiment, the program database is accessed over the Internet. The program database returns a program identifier associated to the channel and time for the location, or cable or terrestrial system used by the user. In step 435, the description generator receives the program identifier from the external program database.

In step 440, the program identifier is submitted to an Internet information database. In one embodiment, the Internet information database includes a website which provides program content information associated with different television programs and/or movies. The website provides program content information related to a program identified by the program identifier. In another embodiment, the Internet information database includes a search engine for locating the program content information. In step 450, the description generator receives the program content information from the Internet database. In step 460, the description generator provides a portion of the program content information received in step 450. In one embodiment, the user selects several options to identify the level of information detail and the type of information to display. For example, a user may select to only be provided with a brief plot synopsis or actor listing. Accordingly, the description generator may filter through the received program content information to select only the type of information selected by the user.

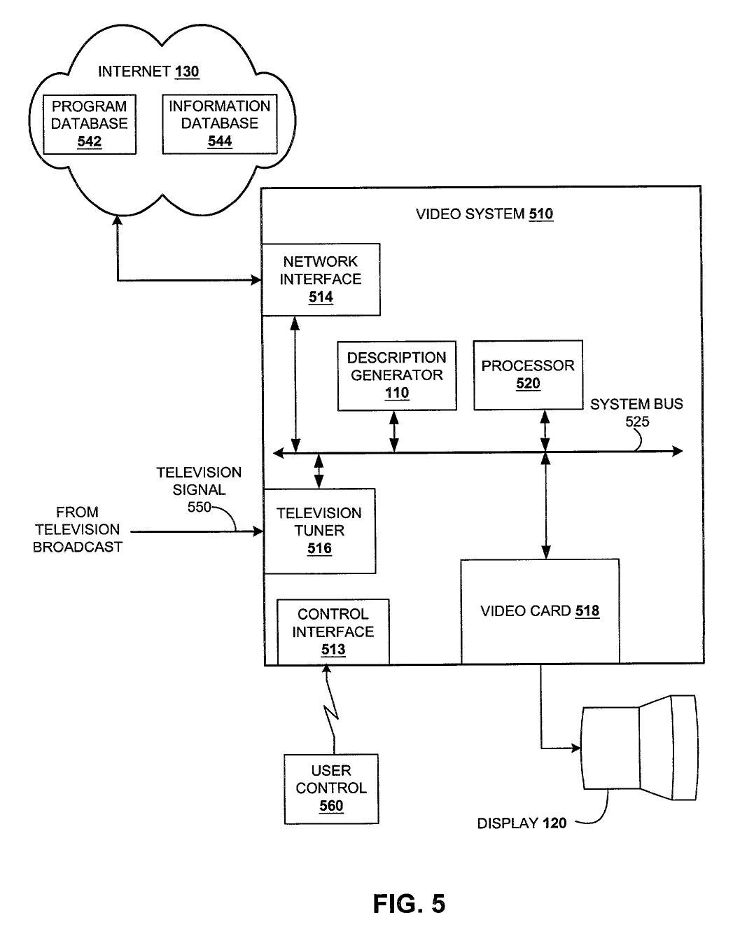

Referring now to FIG. 5, a block diagram illustrating a more detailed implementation of the system from FIG. 1 is shown, according to one embodiment of the present invention. A video system 510 is used to provide video content from a television signal 550 on a display 120. A user accesses video system 510 through user control 560. The user selects to receive information regarding particular television programs. Information regarding the program is generated by description generator 110 and displayed with the video on display 120.

Video content from a television channel of television signal 550 is selected and decoded by television tuner 516. In one embodiment, a user selects the channel to be processed by television tuner 516. The television tuner 516 provides video content related to a program being presented on the television channel. The video content is processed and placed on system bus 525. The video content may then be read from system bus 525 by video card 518. Video card 518 processes the video content and displays a representation of the video content on display 120.

User control 560 may include an infrared, or radio frequency remote control unit, interfaced with video system 510 through control interface 513. The user may select various channels to be displayed through control interface 513. Control interface 513 generates system signals related to commands from user control 560. The user signals are then used to control portions of video system 510. In one embodiment, a user requests program content information through user control 560. A description generator 110 is used to provide information related to particular programs of channels in television signal 550, as requested by the user.

Description generator 110 accesses program database 542 and information database 544 from Internet 130 to access the requested program content information, through network interface 514. Program database 542 is used to provide a program identifier associated with a particular television channel and time specified by the description generator 110. In one embodiment, the user requests information related to the current television channel being watched by the user through display 120. The description generator 110 provides the current television channel tuned by television tuner 516 and a current time specified by clock 511 to program database 542. Alternatively, the user may provide an alternate channel and/or future time to request program content information related to another or future program. Accordingly, the description generator 110 would provide the channel and time requested by the user. In one embodiment, description generator 110 also provides information regarding the location and/or television broadcaster to assist program database 542 in determining the program requested. In an alternate embodiment, the program database 542 is provided through an internal component of video system 510.

The program database 542 provides the program identifier associated with the time and channel specified by description generator 110. In one embodiment, the program identifier includes the title of the requested program. The description generator 110 provides the program identifier to a information database 544, through network interface 514. In one embodiment, information database 544 includes a website for providing program content information related to various programs. Information database 544 uses the program identifier to locate a set of information about the program. In another embodiment, information database 544 includes a search engine for searching the Internet 544 for information associated with the program identifier. Description generator 110 accesses the program content information returned by information database 544, through network interface 514 and Internet 130.

In one embodiment, the description generator 110 filters the program content information against types of information requested by the user, as shown in reference to FIG. 2. For example, the user may select to only receive a listing of actors related to the program. Accordingly, description generator 110 only provides information from the received program content information associated with actor lists. The description generator 110 provides the filtered information to video card 518, through system bus 525. In one embodiment, video card 518 mixes the video content from television tuner 516 with the filtered information from description generator 110 and displays the mixed video on display 120. In one embodiment, description generator 110 includes a software program run using processor 520. In another embodiment, description generator 110 includes hardware designed to handle the tasks described herein.

In another embodiment, description generator 110 is used to access audio program content information. Description generator 110 may provide a time and radio station associated with a particular song to a station play-list similar to program database 542. Some radio stations provide play-lists indicating the names of audio programs or songs being played. Description generator 110 may then provide the program or song title to information database 544 to receive information related to the song, such as the artist name. It will be appreciated that other multimedia systems and or components may be used with description generator 110 and/or video system 510 without departing from the scope of the present invention.

The systems described herein may be part of an information handling system. The term “information handling system” refers to any system that is capable of processing information or transferring information from one source to another. An information handling system may be a single device, such as a computer, a personal digital assistant (PDA), a hand held computing device, a cable set-top box, an Internet capable device, such as a cellular phone, and the like. Alternatively, an information handling system may refer to a collection of such devices. It should be appreciated that while components of the system have been describes in reference to video and audio processing components, the present invention may be practiced using other types of system components. It should be appreciated that the system described herein has the advantage of accessing and providing information related to a multimedia program.

In the preceding detailed description of the embodiments, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising:
obtaining a program identifier from a program database, wherein the program identifier is associated with a particular program;
accessing program content information associated with the program identifier from an information database; and
providing at least a portion of the program content information to a user.

2. The method as in claim 1, further including the steps of:
receiving a time and a channel associated with the particular program; and
providing the time and the channel to the program database.

3. The method as in claim 2, wherein the channel is accessed from a tuner.

4. The method as in claim 2, wherein the channel is specified by the user.

5. The method as in claim 1, wherein the program database includes an Internet database.

6. The method as in claim 1, wherein the information database is accessible through the Internet.

7. The method as in claim 1, wherein the information database includes an Internet search engine.

8. The method as in claim 1, wherein the particular program is a multimedia program.

9. The method as in claim 8, wherein the multimedia program is a television program, a current program, or a future program.

10. The method as in claim 1, wherein the particular program is an audio program.

11. The method as in claim 1, wherein the particular program is selected by the user.

12. The method as in claim 1, wherein the at least a portion of the program content information is a brief description of the particular program.

13. The method as in claim 11, wherein the brief description includes an actor listing.

14. The method as in claim 1, wherein the at least a portion of the program content information is a detailed description of the particular program.

15. The method as in claim 1, wherein the program identifier is a program title.

16. The method as in claim 1, wherein providing the at least a portion of the program content information includes displaying the representation of the program content information on a display device.

17. The method as in claim 1, further including the step of providing an advertisement associated with the information database to the user.

18. A system comprising:
a network interface to access:
an information database to provide program content information associated with a program identifier, wherein the program identifier is associated with a particular program and provided from a program database;
a description generator to:
obtain said program identifier from said program database;
access said program content information from said information database through said network interface;
present said program content information to a display device; and
said display to provide said program content information.

19. The system as in claim 18, wherein said program database is accessed through said network interface.

20. The system as in claim 18, further including a control interface to receive a request to present said program content information related to said particular program.

21. The system as in claim 20, wherein said request includes a time and a channel associated with said particular program.

22. The system as in claim 21, wherein said time and said channel are provided to said program database.

23. The system as in claim 18, wherein said particular program is presented on said display.

24. The system as in claim 18, further including a tuner to decode said particular program.

25. The system as in claim 18, wherein said particular program is a multimedia program.

26. The system as in claim 18, wherein said program content information includes a brief description of said particular program.

27. The system as in claim 18, wherein said program content information includes a detailed description of said particular program.

28. The system as in claim 18, wherein said program identifier includes a program title associated with said particular program.

29. The system as in claim 18, wherein said information database includes an Internet website.

30. The system as in claim 18, wherein said information database includes an Internet search engine.

31. The system as in claim 18, further used to provide an advertisement associated with the information database.

32. A computer readable medium tangibly embodying a program of instructions, said program of instructions comprising instructions to:
obtain a program identifier from a program database, wherein the program identifier is associated with a particular program;
access program content information associated with the program identifier from an information database; and
provide at least a portion of the program content information to a user.

33. The computer readable medium as in claim 32, said program of instructions further used to:
receive a time and a channel associated with the particular program; and
provide the time and the channel to the program database.

34. The computer readable medium as in claim 33 wherein the channel is accessed from a tuner.

35. The computer readable medium as in claim 33, wherein the channel is specified by the user.

36. The computer readable medium as in claim 32, wherein the program database includes an Internet database.

37. The computer readable medium as in claim 32, wherein the information database is accessible through the Internet.

38. The computer readable medium as in claim 32, wherein the information database includes an Internet search engine.

39. The computer readable medium as in claim 32, wherein the particular program is a multimedia program.

40. The computer readable medium as in claim 32, wherein the at least a portion of the program content information is a brief description of the program content information.

41. The computer readable medium as in claim 40, wherein the brief description includes an actor listing.

42. The computer readable medium as in claim 32, wherein the at least a portion of the program content information is a detailed description of the program content information.

43. The computer readable medium as in claim 32, wherein the program identifier is a program title.

44. The computer readable medium as in claim 32, wherein providing the at least a portion of the program content information includes displaying the representation of the program content information on a display device.

45. The computer readable medium as in claim 32, wherein said program of instructions further comprising instructions to present an advertisement associated with the information database to the user.
